(19) United States
(12) Patent Application Publication
(10) Pub. No.: US 2020/0023523 A1
(43) Pub. Date: Jan. 23, 2020

(54) ROBOT CONTROL SYSTEM, ROBOT APPARATUS, AND NON-TRANSITORY COMPUTER READABLE MEDIUM

(71) Applicant: FUJI XEROX CO., LTD., Tokyo (JP)

(72) Inventors: Yoshimi UEZU, Kanagawa (JP); Junichi TAMURA, Kanagawa (JP); Takahiro MINAMIKAWA, Kanagawa (JP); Kunitoshi YAMAMOTO, Kanagawa (JP)

(73) Assignee: FUJI XEROX CO., LTD., Tokyo (JP)

(21) Appl. No.: 16/506,999

(22) Filed: Jul. 9, 2019

(30) Foreign Application Priority Data
Jul. 17, 2018 (JP) 2018-133986

(51) Int. Cl. B25J 9/16

(52) U.S. Cl. CPC B25J 9/1697; B25J 9/1676; B25J 9/1666

(57) ABSTRACT

A robot control system includes a robot apparatus that operates autonomously in accordance with control information provided to the robot apparatus, the robot apparatus receiving update information to be used to update the control information and updating the control information in accordance with the received update information, an imaging apparatus that captures an image of the robot apparatus, and a control apparatus including a transmitting unit that transmits to the robot apparatus update information generated in accordance with the image captured by the imaging apparatus.

### CROSS-REFERENCE TO RELATED APPLICATIONS

This application is based on and claims priority under 35 USC 119 from Japanese Patent Application No. 2018-133986 filed Jul. 17, 2018.

### BACKGROUND

### (i) Technical Field

The present disclosure relates to a robot control system, a robot apparatus, and a non-transitory computer readable medium.

### (ii) Related Art

Japanese Unexamined Patent Application Publication No. 2006-247803 discloses an autonomous mobile robot that tilts the robot body to change the scanning range of an obstacle detection sensor.

### SUMMARY

Aspects of a non-limiting embodiment of the present disclosure relate to providing a robot control system, a robot apparatus, and a non-transitory computer readable medium that enable control information for controlling operation of a robot apparatus to reflect a control condition that is not determined unless the robot apparatus is observed from outside.

Aspects of a certain non-limiting embodiment of the present disclosure address the above advantages and/or other advantages not described above. However, aspects of the non-limiting embodiment are not required to address the advantages described above, and aspects of the non-limiting embodiment of the present disclosure may not address advantages described above.

According to an aspect of the present disclosure, there is provided a robot control system that includes a robot apparatus that operates autonomously in accordance with control information provided to the robot apparatus, the robot apparatus receiving update information to be used to update the control information and updating the control information in accordance with the received update information, an imaging apparatus that captures an image of the robot apparatus, and a control apparatus including a transmitting unit that transmits to the robot apparatus update information generated in accordance with the image captured by the imaging apparatus.

### BRIEF DESCRIPTION OF THE DRAWINGS

An exemplary embodiment of the present disclosure will be described in detail based on the following figures, wherein:

FIG. 1 depicts an external appearance of a robot apparatus controlled by a robot control system according to an exemplary embodiment of the present disclosure;

FIG. 2 depicts an example external appearance of the robot apparatus depicted in FIG. 1 when a load is placed on an upper surface of the robot apparatus;

FIG. 3 depicts a system configuration of the robot control system according to the exemplary embodiment of the present disclosure;

FIG. 4 illustrates relative positions of cameras with respect to the reference measurement point for setting up the robot apparatus;

FIG. 5 is a block diagram illustrating a hardware configuration of the robot apparatus according to the exemplary embodiment of the present disclosure;

FIG. 6 is a block diagram illustrating a functional configuration of the robot apparatus according to the exemplary embodiment of the present disclosure;

FIG. 7 is a block diagram illustrating a hardware configuration of a control server according to the exemplary embodiment of the present disclosure;

FIG. 8 is a block diagram illustrating a functional configuration of the control server according to the exemplary embodiment of the present disclosure;

FIG. 9 is a sequence chart for illustrating an operation of the robot control system according to the exemplary embodiment of the present disclosure;

FIG. 10 is an illustration of an example piece of three-dimensional (3D) model data;

FIGS. 11A and 11B are drawings for illustrating the measurement of the maximum external dimensions of the robot apparatus as a control parameter set;

FIG. 12 depicts information regarding external dimensions of the robot apparatus as an example control parameter set;

FIG. 13 depicts a system configuration for capturing an image of the robot apparatus by using a single camera only;

FIG. 14 is a sequence chart for illustrating an operation of generating a control parameter set by capturing images of the robot apparatus in operation by using a single camera;

FIG. 15 illustrates the camera capturing an image of the robot apparatus carrying loads during operation;

FIG. 16 illustrates the camera capturing an image of the robot apparatus carrying a robot arm;

FIG. 17A illustrates a movable unit as a separate body, and FIG. 17B illustrates the robot apparatus equipped with the movable unit; and

FIG. 18 illustrates a case where the external form of the robot apparatus changes and thereby a control parameter set changes in accordance with the changed external form of the robot apparatus.

### DETAILED DESCRIPTION

An exemplary embodiment of the present disclosure will be described in detail with reference to the drawings.

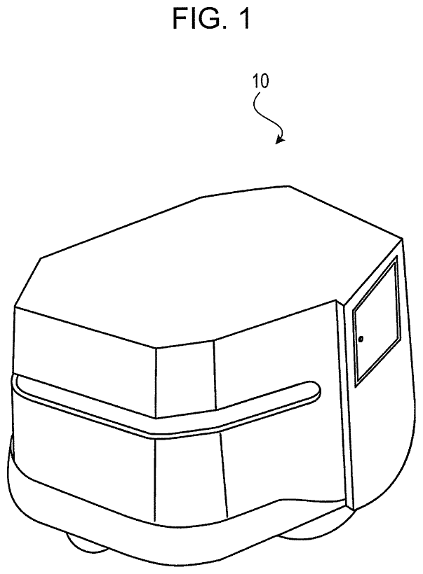

First, FIG. 1 depicts an external appearance of a robot apparatus 10 controlled by a robot control system according to the exemplary embodiment of the present disclosure.

As depicted in FIG. 1, the robot apparatus 10 has an upper surface designed to be able to carry various objects, such as packages. Rotatable bodies such as tires are disposed underneath the robot apparatus 10, so that the rotation of the rotatable bodies enables the robot apparatus 10 to move autonomously while carrying various objects. Control information such as a control program and a control parameter set is provided to the robot apparatus 10 in advance, and the robot apparatus 10 is configured to operate autonomously in accordance with the provided control information.

For example, a control parameter set regarding the external form (external dimensions) of the robot apparatus 10 carrying no load is provided to the robot apparatus 10, and thereby the robot apparatus 10 controls operation of the robot body in accordance with the control parameter set and performs an operation such as bypassing an obstacle and determining whether a narrow path or the like is passable for the robot body. In addition, when a path to a destination is searched for by using map information prepared in advance, a path search based on the result of determining whether a path is passable as described above is possible.

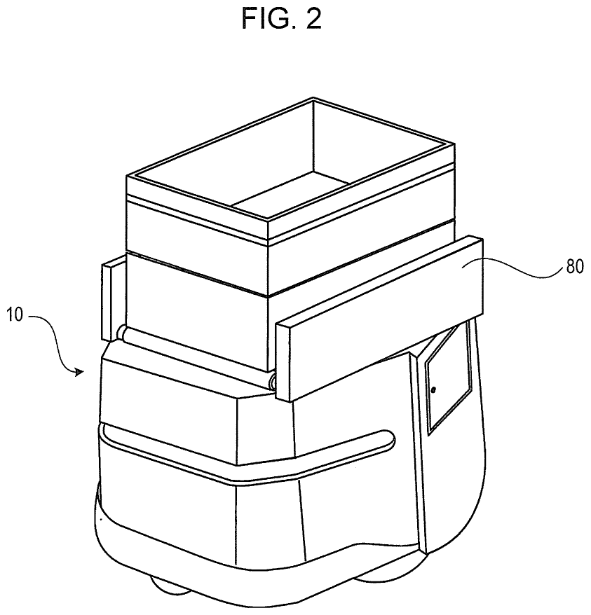

Next, FIG. 2 depicts an example external appearance of the robot apparatus 10 depicted in FIG. 1 when a load 80 is placed on the upper surface of the robot apparatus 10. Referring to FIG. 2, the load 80 is placed on the upper surface of the robot apparatus 10, and it is found that the height, width, and depth dimensions change when the robot apparatus 10 is loaded.

Thus, when the robot apparatus 10 performs an operation for bypassing an obstacle or turning around, if the robot apparatus 10 allows a margin between the obstacle and the robot body in accordance with a control parameter set provided by using the external form (external dimensions) of the robot body carrying no load, the load 80 placed on the robot body may come into contact with an obstacle around the robot body.

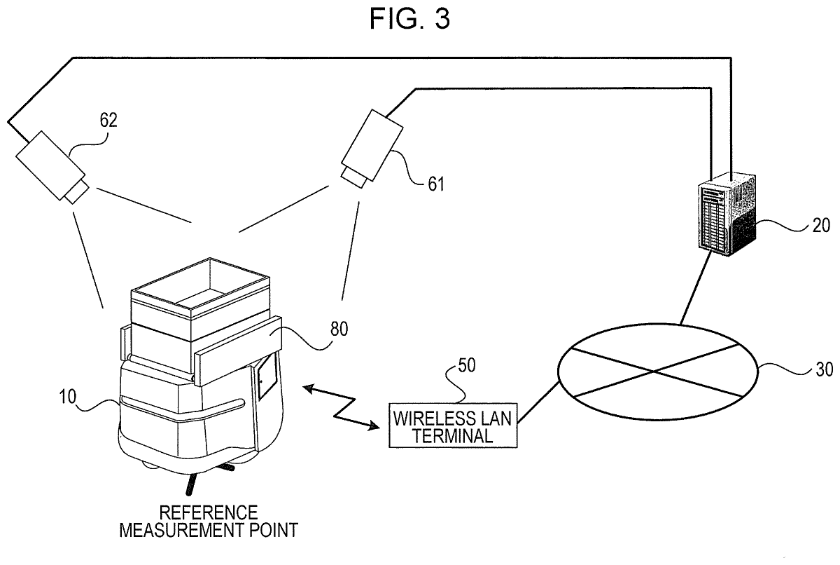

The robot control system according to the present exemplary embodiment has the following configuration so as to avoid such a situation. As depicted in FIG. 3, the robot control system according to the exemplary embodiment of the present disclosure includes the robot apparatus 10 and a control server 20, which are connected via a network 30, and cameras 61 and 62.

The robot apparatus 10 is configured to be connectable to the network 30 via a wireless local-area network (LAN) terminal 50.

The cameras 61 and 62 function as an imaging unit and capture an image of the robot apparatus 10, which is positioned at a predetermined reference measurement point. The cameras 61 and 62 each capture from different directions an image of the external appearance of the robot apparatus 10, which is positioned at the predetermined reference measurement point.

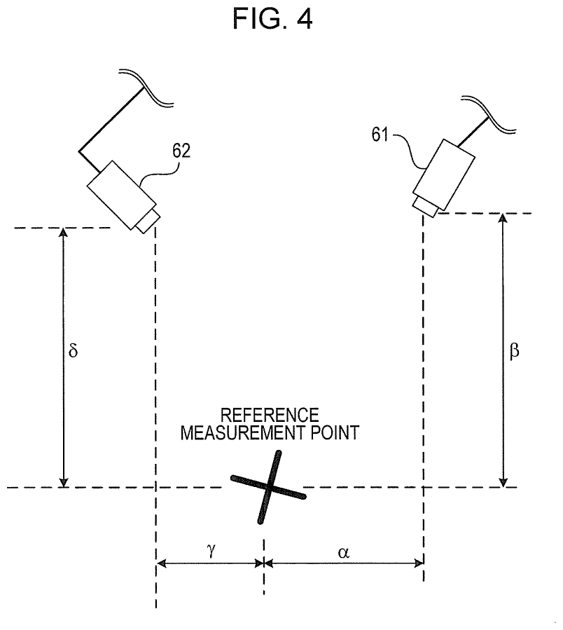

As depicted in FIG. 4, positional information α, β, γ, and δ of the cameras 61 and 62 with respect to the reference measurement point for setting up the robot apparatus 10 is obtained in advance and registered in the control server 20.

Instead of using a typical red-green-blue (RGB) camera as the cameras 61 and 62, if a stereo camera or a distance measurement sensor capable of measuring the distance to an object, such as a laser range finder (LRF), is used, it is possible to calculate the external form or other parameters of the robot apparatus 10 without obtaining the positional information of each of the cameras 61 and 62 with respect to the reference measurement point.

The control server 20 generates update information in accordance with images captured by the cameras 61 and 62 and the positional information of each of the cameras 61 and 62 with respect to the reference measurement point described above. The update information is used to update control information for controlling operation of the robot apparatus 10, and the control server 20 transmits the generated update information to the robot apparatus 10.

The update information is information to update control information such as a control program and a control parameter set necessary for the robot apparatus 10 to move autonomously. Specifically, the update information is, for example, a new control parameter set and control program to replace the control parameter set and control program stored in the robot apparatus 10.

Alternatively, the update information may be instruction information providing instructions to update the control parameter set and control program stored in the robot apparatus 10. More specifically, the robot apparatus 10 may store in advance a plurality of pieces of control information having different control characteristics and may select in accordance with the instruction information provided by the control server 20 one piece of control information from the plurality of pieces of stored control information. Then, the robot apparatus 10 may replace the control information for performing autonomous operation with the selected piece of control information.

Further, the control server 20 may transmit image information of the robot apparatus 10, whose images are captured by the cameras 61 and 62, to the robot apparatus 10 as the update information. In such a case, the robot apparatus 10 generates new control information in accordance with the image information received from the control server 20 and replaces the control information for performing autonomous operation with the generated control information.

In the following description, a configuration in which the control server 20 generates in accordance with image information obtained by the cameras 61 and 62 a new control parameter set for controlling the movement operation of the robot apparatus 10 and transmits the generated control parameter set to the robot apparatus 10 will mainly be described.

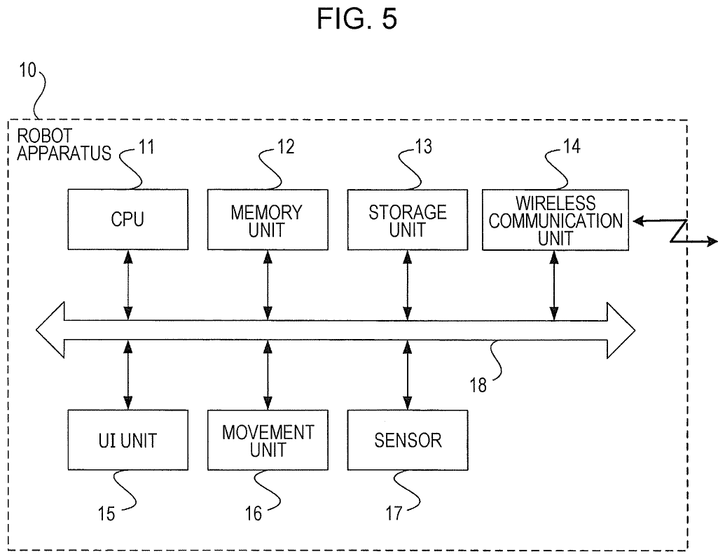

Next, FIG. 5 depicts a hardware configuration of the robot apparatus 10 in the robot control system according to the present exemplary embodiment.

As depicted in FIG. 5, the robot apparatus 10 includes a central processing unit (CPU) 11, a memory unit 12, a storage unit 13 such as a hard disk drive (HDD), a wireless communication unit 14 that wirelessly transmits and receives data to and from an external apparatus and the like, a user interface (UI) unit 15 including a touch panel or a liquid crystal display and a keyboard, a movement unit 16 for moving the robot apparatus 10, and a sensor 17 for detecting information such as an obstacle around the robot apparatus 10. These units are connected to each other via a control bus 18.

The CPU 11 performs predetermined processing in accordance with a control program stored in the memory unit 12 or in the storage unit 13 and controls operation of the robot apparatus 10. Although the description regarding the present exemplary embodiment will be provided assuming that the CPU 11 reads and executes the control program stored in the memory unit 12 or in the storage unit 13, it is also possible to provide the CPU 11 with a control program stored on a recording medium such as a compact-disc read-only memory (CD-ROM).

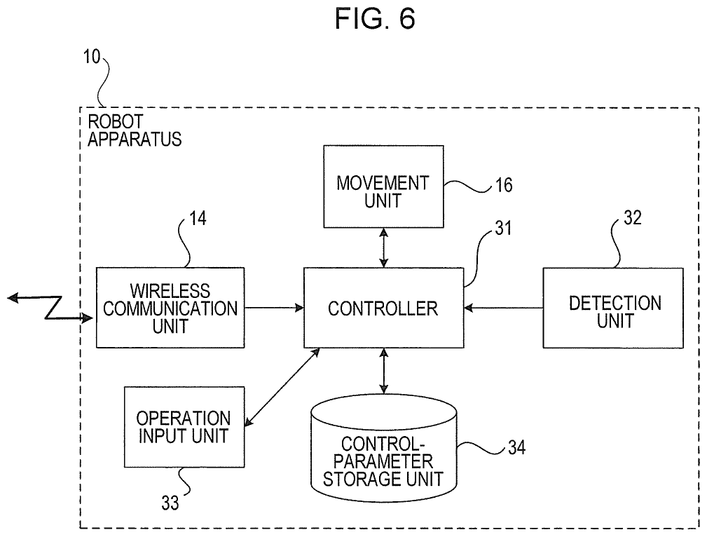

FIG. 6 is a block diagram illustrating a functional configuration of the robot apparatus 10 realized by executing the control program described above.

As depicted in FIG. 6, the robot apparatus 10 according to the present exemplary embodiment includes the wireless communication unit 14, the movement unit 16, a controller 31, a detection unit 32, an operation input unit 33, and a control-parameter storage unit 34.

The wireless communication unit 14, which is connected to the network 30 via the wireless LAN terminal 50, transmits and receives data to and from the control server 20.

The movement unit 16 is controlled by the controller 31 and moves the body of the robot apparatus 10. The operation input unit 33 receives various pieces of operation information such as instructions from a user.

The detection unit 32 uses various sensors, such as a LRF, to detect an obstacle present around the robot apparatus 10, such as an object or a person, and determines the size of the obstacle, the distance to the obstacle, and the like.

The control-parameter storage unit 34 stores various control parameter sets for controlling the movement of the robot apparatus 10.

The controller 31 autonomously controls in accordance with a provided control parameter set operation of the robot apparatus 10 in which the controller 31 is installed. Specifically, in addition to referencing information detected by the detection unit 32, the controller 31 controls the movement unit 16 in accordance with a control parameter set stored in the control-parameter storage unit 34 and thereby controls the movement of the robot apparatus 10. More specifically, the controller 31 uses a new control parameter set received from the control server 20 and performs, in accordance with the new control parameter set received from the control server 20, one or both of an operation for bypassing an obstacle to avoid a collision between the robot apparatus 10 and the obstacle and determination of whether a path ahead of the robot apparatus 10 is passable for the robot apparatus 10.

Upon receiving a new control parameter set from the control server 20 as update information via the wireless communication unit 14, the controller 31 updates the control parameter set, which is stored in the control-parameter storage unit 34, in accordance with the received control parameter set. This update information is determined in accordance with a captured image of the external appearance of the robot apparatus 10 in which the controller 31 is installed.

Alternatively, the control-parameter storage unit 34 may store in advance a plurality of control parameter sets having different control characteristics. In such a case, the controller 31 receives from the control server 20 via the wireless communication unit 14 instruction information providing instructions to update the control parameter set to be used to control the robot apparatus 10 and selects in accordance with the received instruction information a control parameter set to be used from the plurality of control parameter sets stored in the control-parameter storage unit 34.

When image information obtained by the cameras 61 and 62 is received from the control server 20 instead of a new control parameter set, the controller 31 generates in accordance with the received image information a new control parameter set for controlling the robot apparatus 10. Then, the generated new control parameter set is stored in the control-parameter storage unit 34, and the robot apparatus 10 operates autonomously in accordance with the new control parameter set.

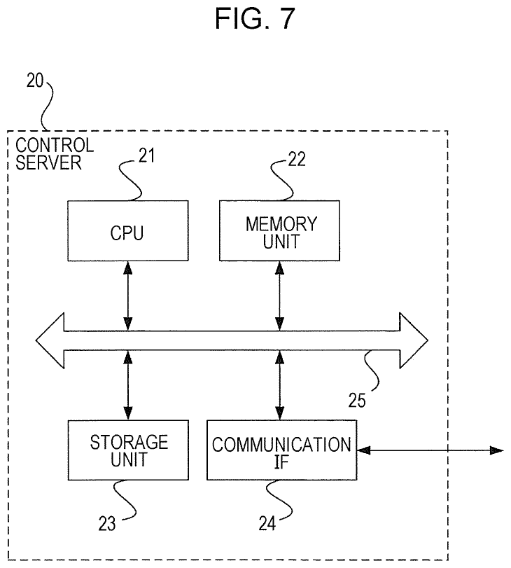

Next, FIG. 7 depicts a hardware configuration of the control server 20 in the robot control system according to the present exemplary embodiment.

As depicted in FIG. 7, the control server 20 includes a CPU 21, a memory unit 22, a storage unit 23 such as an HDD, and a communication interface (IF) 24. The communication IF 24 transmits and receives data to and from an external apparatus and the like via the network 30. These units are connected to each other via a control bus 25.

The CPU 21 performs predetermined processing in accordance with a control program stored in the memory unit 22 or in the storage unit 23 and controls operation of the control server 20. Although the description regarding the present exemplary embodiment will be provided assuming that the CPU 21 reads and executes the control program stored in the memory unit 22 or in the storage unit 23, it is also possible to provide the CPU 21 with a control program stored on a recording medium such as a CD-ROM.

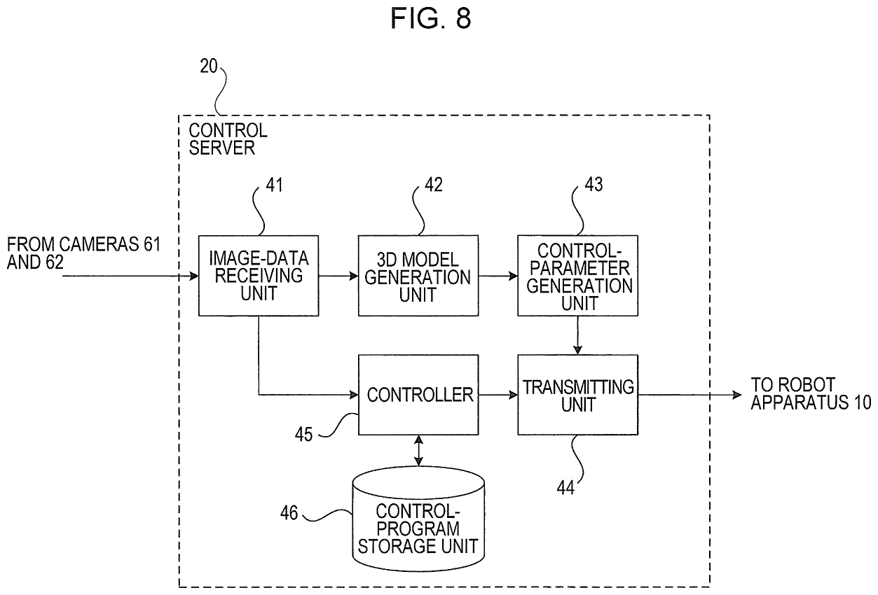

FIG. 8 is a block diagram illustrating a functional configuration of the control server 20 realized by executing the control program described above.

As depicted in FIG. 8, the control server 20 according to the present exemplary embodiment includes an image-data receiving unit 41, a three-dimensional (3D) model generation unit 42, a control-parameter generation unit 43, a transmitting unit 44, a controller 45, and a control-program storage unit 46.

The image-data receiving unit 41 receives captured image data of the robot apparatus 10 from the cameras 61 and 62.

The 3D model generation unit 42 generates a three-dimensional model (3D model) of the robot apparatus 10 from image data (image information) of the robot apparatus 10, the image data being received by the image-data receiving unit 41.

The control-parameter generation unit 43 generates a control parameter set for controlling the robot apparatus 10 from the 3D model of the robot apparatus 10, the 3D model being generated by the 3D model generation unit 42. In other words, the control-parameter generation unit 43 generates in accordance with the images captured by the cameras 61 and 62, which constitute an imaging apparatus, a control parameter set for controlling the robot apparatus 10.

Specifically, the control parameter set is generated from positional information of each of the cameras 61 and 62 with respect to the position at which the robot apparatus 10 is placed and the respective images captured by the two cameras 61 and 62.

The transmitting unit 44 transmits to the robot apparatus 10 the control parameter set generated by the control-parameter generation unit 43.

In the description of the present exemplary embodiment, the control parameter set, which is information regarding the external dimensions of the robot apparatus 10, is generated by the control-parameter generation unit 43 and transmitted to the robot apparatus 10 by the transmitting unit 44, but information other than the information regarding the external dimensions may be transmitted to the robot apparatus 10 as a control parameter set.

The controller 45 may cause the transmitting unit 44 to transmit image information of the robot apparatus 10, the image information being received by the image-data receiving unit 41, to the robot apparatus 10 as the update information without processing the image information.

Alternatively, the controller 45 may transmit to the robot apparatus 10 instruction information, which provides instructions to update the control parameter set used to control the robot apparatus 10, as the update information.

The control-program storage unit 46 stores in advance a plurality of control programs having different control characteristics. The controller 45 identifies the type of the robot apparatus 10 by using images of the robot apparatus 10 captured by the cameras 61 and 62, selects a control program that corresponds to the identified type of the robot apparatus 10 from the plurality of control programs stored in the control-program storage unit 46, and causes the transmitting unit 44 to transmit the selected control program to the robot apparatus 10.

The control-program storage unit 46 may store in advance a plurality of control programs each of which corresponds to an individual robot apparatus 10. In such a case, the controller 45 identifies an individual robot apparatus 10 by using images of the robot apparatus 10 captured by the cameras 61 and 62, selects a control program that corresponds to the identified individual robot apparatus 10 from the plurality of control programs stored in the control-program storage unit 46, and causes the transmitting unit 44 to transmit the selected control program to the robot apparatus 10.

It is also possible to configure the robot apparatus 10 to transmit information to enable the type of the robot apparatus 10 or the individual robot apparatus 10 to be identified. In such a case, the controller 45 may identify the type of the robot apparatus 10 or the individual robot apparatus 10 by using the information received from the robot apparatus 10 instead of images of the robot apparatus 10 captured by the cameras 61 and 62.

Operation of the robot control system according to the present exemplary embodiment will be described in detail with reference to the drawings.

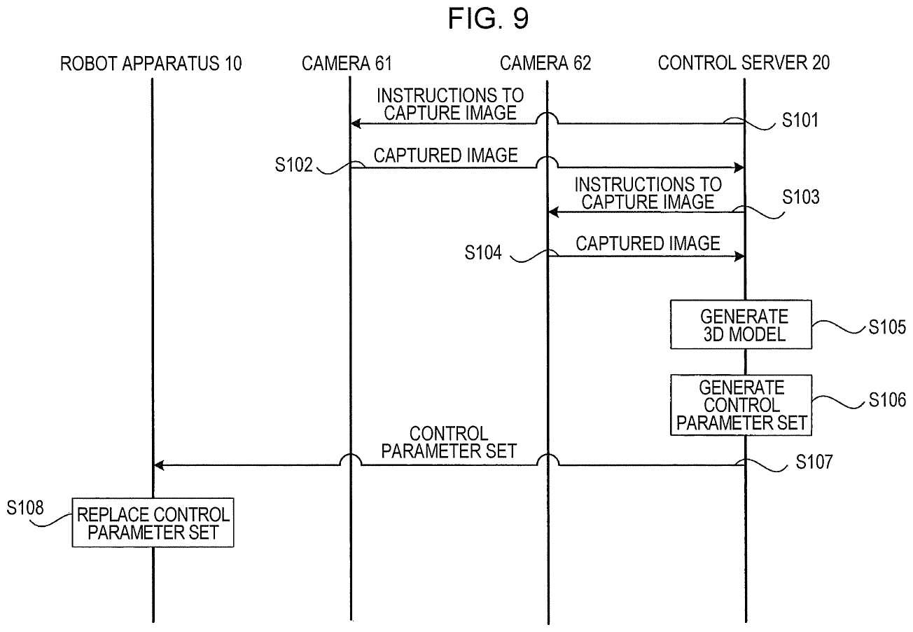

Operation of the robot control system according to the present exemplary embodiment will be described with reference to the sequence chart in FIG. 9.

First, the robot apparatus 10 is placed at the reference measurement point described with reference to FIGS. 3 and 4. The control server 20 provides each of the cameras 61 and 62 with instructions to capture an image and thereafter receives a captured image from each of the cameras 61 and 62 (steps S101 to S104).

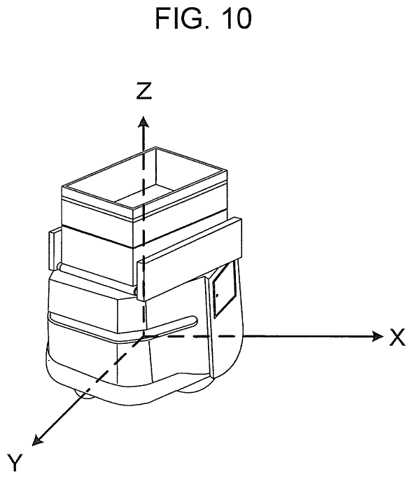

Then, the 3D model generation unit 42 in the control server 20 generates a 3D model of the robot apparatus 10 from the two captured images (step S105). FIG. 10 depicts example 3D model data generated in this manner. In FIG. 10, 3D model data of the external form of the robot apparatus 10 carrying the load 80 is generated in the X-axis, Y-axis, and Z-axis directions (width, depth, and height directions) with the reference position of the robot apparatus 10 as the origin.

It is also possible to transmit the 3D model data directly to the robot apparatus 10 from the control server 20 and to cause the robot apparatus 10 to control movement in accordance with the received 3D model data.

Next, the control-parameter generation unit 43 generates as a control parameter set, for example, information regarding the external dimensions in the width, depth, and height directions of the robot apparatus 10 from the 3D model data generated as described above (step S106).

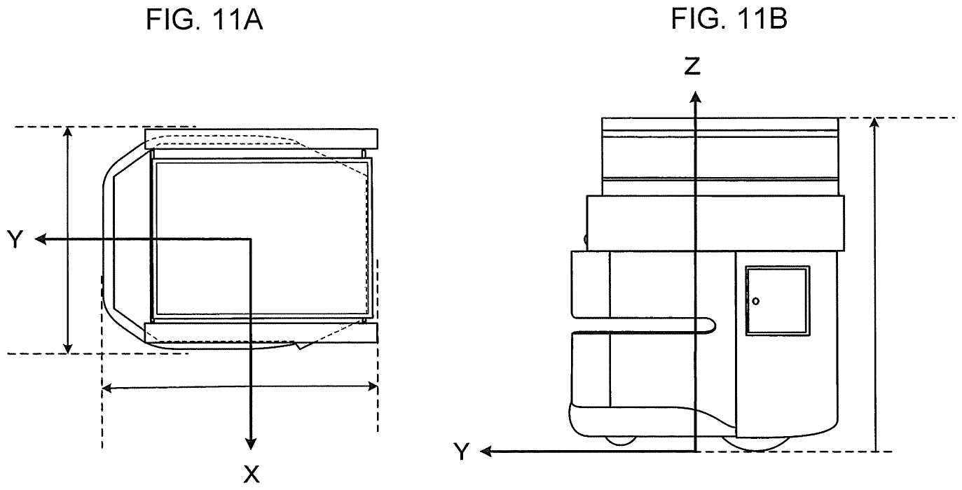

For example, as depicted in FIGS. 11A and 11B, the control-parameter generation unit 43 measures the maximum external dimensions of the robot apparatus 10 in the X-axis, Y-axis, and Z-axis directions as described above and generates a control parameter set.

The new control parameter set generated by the control-parameter generation unit 43 is transmitted to the robot apparatus 10 (step S107).

The robot apparatus 10 replaces the provided control parameter set with the new control parameter set, which is received from the control server 20 (step S108).

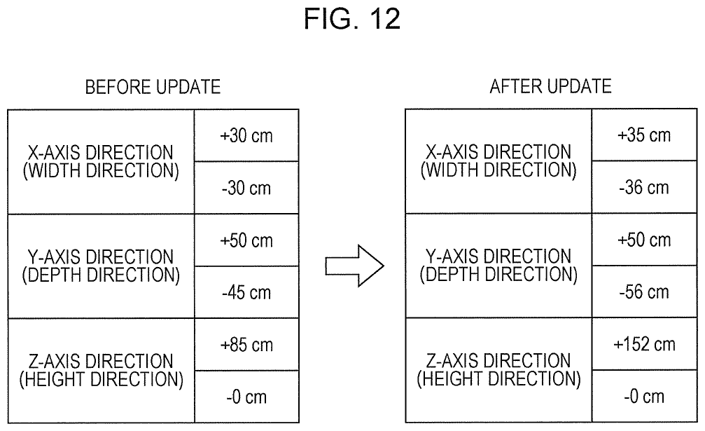

FIG. 12 depicts an example control parameter set updated in this manner. In the example depicted in FIG. 12, a control parameter set regarding the external dimensions is updated. The control parameter set has been provided to the robot apparatus 10 and is replaced with a new control parameter set, which is generated by the control-parameter generation unit 43.

The control parameter set provided to the robot apparatus 10 is replaced with a new control parameter set, and it is found that the external dimensions in the height, depth, and width directions increase.

In summary, updating the control parameter set enables the robot apparatus 10 to perform autonomous movement control in accordance with the external dimensions of the robot apparatus 10 carrying the load 80 and to perform processing such as bypassing an obstacle, ensuring a margin during a turn, and determining whether a path ahead of the robot apparatus 10 is passable.

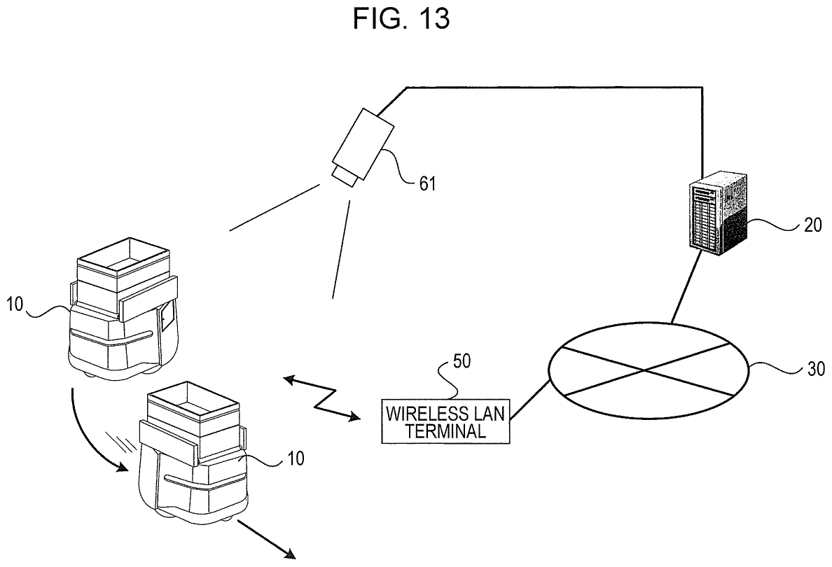

A case where the two cameras 61 and 62 capture the images of the robot apparatus 10 is described with reference to FIG. 3, but, as depicted in FIG. 13, only one camera 61 may capture the image of the robot apparatus 10.

In the configuration as depicted in FIG. 13, the camera 61 captures a plurality of times an image of the external appearance of the robot apparatus 10 in operation. Then, a control parameter set is generated from the distance traveled by the robot apparatus 10 and a plurality of images captured by the camera 61.

Specifically, operation of the robot apparatus 10 is controlled by the control server 20, a controller, or the like (not depicted), and the robot apparatus 10 is operated so that the entire body of the robot apparatus 10 is captured by the camera 61.

Then, while the robot apparatus 10 is being operated, the camera 61 captures a plurality of times an image of the external appearance of the robot apparatus 10. Simultaneously, a distance traveled by the robot apparatus 10 is estimated by using the number of rotations of a wheel of the robot apparatus 10, and the control server 20 acquires, as odometry information, the information regarding the distance traveled by the robot apparatus 10 or the like. In the control server 20, a control parameter set is generated from the odometry information and the information regarding the plurality of captured images of the robot apparatus 10.

The robot apparatus 10 may be operated manually or automatically by the control server 20 by using the captured images. When the control server 20 automatically controls operation of the robot apparatus 10, feature points or the like of the robot apparatus 10 are recognized by using the object recognition technology, and operation of the robot apparatus 10 is controlled so that the recognized form of the robot apparatus 10 coincides with the form viewed in the direction from which an image is to be captured.

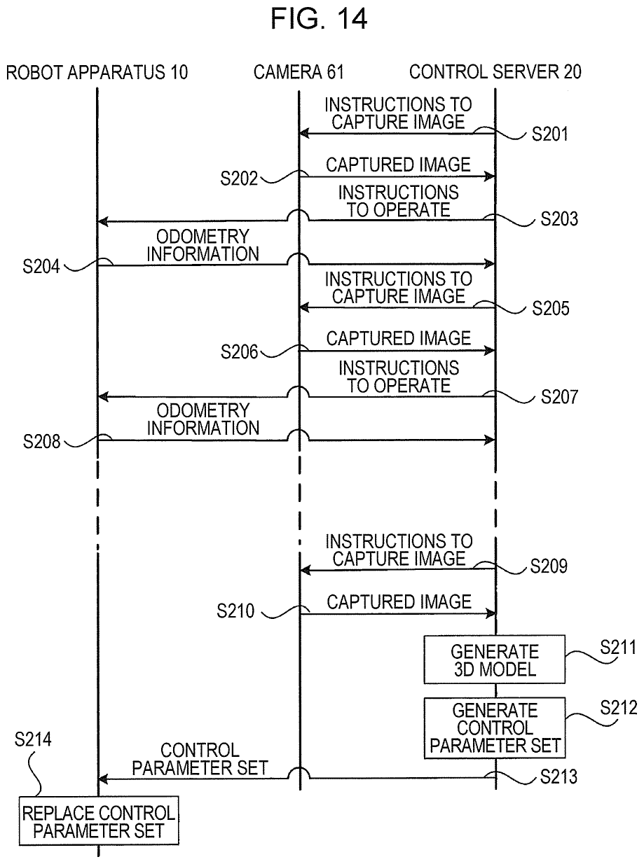

An operation of generating a control parameter set by capturing images of the robot apparatus 10 in operation by using the single camera 61 in this manner will be described with reference to the sequence chart in FIG. 14.

The control server 20 provides the camera 61 with instructions to capture an image, and an image captured by the camera 61 is transmitted to the control server 20 (steps S201 and S202). Then, the control server 20 provides the robot apparatus 10 with instructions to operate (step S203) and receives as odometry information a piece of information such as the distance traveled by the robot apparatus 10, which has received the instructions to operate (step S204).

Then, the control server 20 provides the camera 61 with instructions to capture an image and acquires an image captured by the camera 61 (steps S205 and S206).

Repeating such processing a plurality of times enables the control server 20 to acquire image information of the robot apparatus 10 from various directions (steps S207 to S210).

Then, the control server 20 generates a 3D model of the robot apparatus 10 from the plurality of captured images by using a method similar to the method described above (step S211). A control parameter set is generated from the generated 3D model (step S212).

Finally, the generated control parameter set is transmitted from the control server 20 to the robot apparatus 10 (step S213). Then, the robot apparatus 10 replaces the provided control parameter set with the new control parameter set, which is received from the control server 20 (step S214).

In the exemplary embodiment described above, a case where the information regarding the external dimensions of the robot apparatus 10 is generated as a control parameter set has been described, but a control parameter set is not limited to such information.

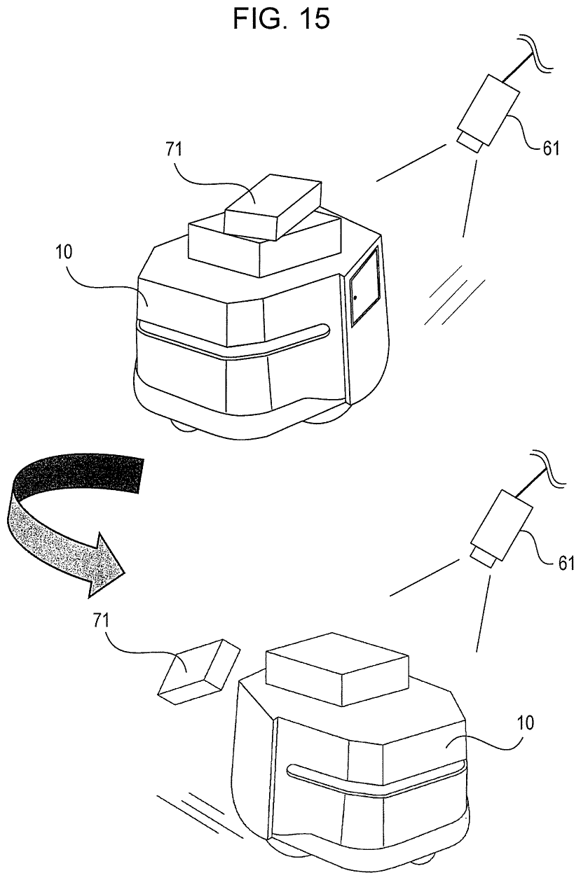

For example, as depicted in FIG. 15, while the robot apparatus 10 carrying a load 71 is operated, the camera 61 captures an image of the load 71 falling from the robot apparatus 10 in operation, and the allowable upper limit on an acceleration value or an angular acceleration value may be generated as a control parameter set and transmitted to the robot apparatus 10.

Specifically, the acceleration value or the angular acceleration value at which the robot apparatus 10 carrying the load 71 is operated is gradually increased, and the acceleration value or the angular acceleration value at the point when the load 71 falls is acquired as the allowable upper limit.

For example, when the robot apparatus 10 is used for an operation such as conveying the same load a plurality of times in a plant, first, the acceleration value or the angular acceleration value at which the robot apparatus 10 carrying the load is operated is gradually increased, and the acceleration value or the angular acceleration value at the point when the fall of the load is detected in a captured image is determined to be the upper limit for the robot apparatus 10 carrying the load.

Such calibration is performed before the operation of conveying the load is started, and thereby it is possible to provide a control parameter set to the robot apparatus 10 before the operation is actually started.

Consequently, the robot apparatus 10 whose control parameter set is replaced with such a control parameter set is capable of an operation for preventing the carried object from falling by using a new control parameter set received from the control server 20.

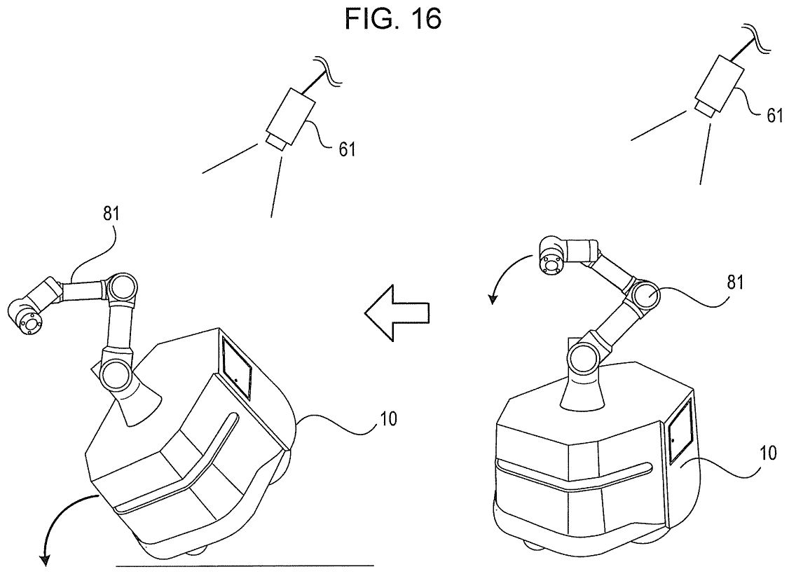

Further, as depicted in FIG. 16, when the robot apparatus 10 to which an robot arm 81 is joined is in operation, it is possible to move the robot arm 81 and find the angle up to which the arm may be moved before the robot arm 81 and the robot apparatus 10 fall down as one body, and a control parameter set for controlling the robot arm 81 may be acquired.

In such a case, a control parameter set for controlling the robot arm 81 is transmitted from the control server 20 to the robot apparatus 10 or to the robot arm 81, and thereby the control parameter set for controlling the robot arm 81 may be updated.

A controller for controlling the robot arm 81 may be installed in the robot arm 81, or the robot apparatus 10 may execute a control program for controlling the robot arm 81 and control the robot arm 81.

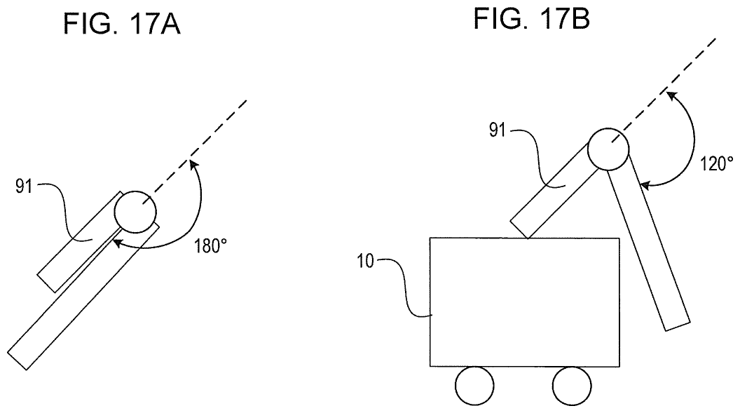

Further, as depicted in FIGS. 17A and 17B, when the robot apparatus 10 is equipped with a movable unit 91, the allowable range of motion for the movable unit 91 may be generated as a control parameter set.

For example, in a case depicted in FIGS. 17A and 17B, the range of motion for the movable unit 91 as a separate body is 180° as depicted in FIG. 17A, and the allowable range of motion for the movable unit 91 fixed to the robot apparatus 10 is 120° as depicted in 17B.

In such a case, the camera 61 is caused to capture an image of the robot apparatus 10 equipped with the movable unit 91 while the movable unit 91 is gradually moved, and the angle information for the movable unit 91 at a point when the movable unit 91 comes into contact with the robot apparatus 10 is acquired by the control server 20 as a new control parameter set.

Then, the robot apparatus 10 acquires information regarding the allowable range of motion for the movable unit 91 from the control server 20 as a control parameter set and replaces the control parameter set for controlling the movable unit 91 with the acquired parameter set. As a result, the robot apparatus 10 is capable of controlling the movable unit 91 to operate so as not to come into contact with the robot apparatus 10.

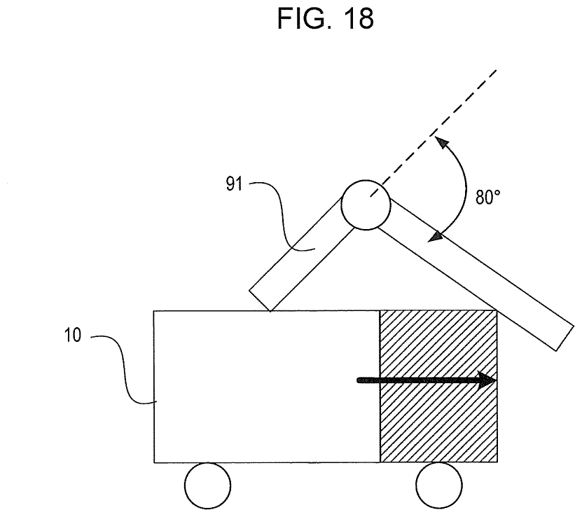

As depicted in FIG. 18, when the external form of the robot apparatus 10 changes, a control parameter set may be generated in accordance with a changed external form of the robot apparatus 10.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A robot control system comprising:
a robot apparatus that operates autonomously in accordance with control information provided to the robot apparatus, the robot apparatus receiving update information to be used to update the control information and updating the control information in accordance with the received update information;
an imaging apparatus that captures an image of the robot apparatus; and
a control apparatus including a transmitting unit that transmits to the robot apparatus update information generated in accordance with the image captured by the imaging apparatus.

2. The robot control system according to claim 1,
wherein the control apparatus further includes a generation unit that generates update information in accordance with the image captured by the imaging apparatus.

3. The robot control system according to claim 1,
wherein the update information is new control information for controlling the robot apparatus.

4. The robot control system according to claim 2,
wherein the update information is new control information for controlling the robot apparatus.

5. The robot control system according to claim 3,
wherein the control apparatus includes a storage unit in which a plurality of pieces of control information, the plurality of pieces of control information having different control characteristics, are stored in advance, the control apparatus identifies a type of the robot apparatus by using an image of the robot apparatus, the image being captured by the imaging apparatus, or by using information received from the robot apparatus, the control apparatus selects a piece of control information corresponding to the identified type of the robot apparatus from the plurality of pieces of control information stored in the storage unit, and the control apparatus transmits the selected piece of control information to the robot apparatus via the transmitting unit.

6. The robot control system according to claim 3,
wherein the control apparatus includes a storage unit in which a plurality of pieces of control information, each of the plurality of pieces of control information corresponding to an individual robot apparatus, are stored in advance, the control apparatus identifies an individual robot apparatus by using an image of the individual robot apparatus, the image being captured by the imaging apparatus, or by using information received from the individual robot apparatus, the control apparatus selects a piece of control information corresponding to the identified individual robot apparatus from the plurality of pieces of control information stored in the storage unit, and the control apparatus transmits the selected piece of control information to the robot apparatus via the transmitting unit.

7. The robot control system according to claim 1,
wherein the update information is instruction information providing instructions to update control information for controlling the robot apparatus.

8. The robot control system according to claim 7,
wherein the robot apparatus includes a storage unit in which a plurality of pieces of control information, the plurality of pieces of control information having different control characteristics, are stored in advance, and the robot apparatus selects in accordance with instruction information received from the control apparatus a piece of control information that is to be used from the plurality of pieces of control information stored in the storage unit.

9. The robot control system according to claim 1,
wherein the update information is image information of the robot apparatus whose image is captured by the imaging apparatus.

10. The robot control system according to claim 9,
wherein the robot apparatus generates in accordance with image information received from the control apparatus new control information for controlling the robot apparatus and performs autonomous operation in accordance with the generated new control information.

11. The robot control system according to claim 3,
wherein the control information is information regarding external dimensions of the robot apparatus.

12. The robot control system according to claim 11,
wherein the robot apparatus uses new control information received from the control apparatus and performs, in accordance with the new control information received from the control apparatus, one or both of an operation for bypassing an obstacle to avoid a collision between the robot apparatus and the obstacle and determination of whether a path ahead of the robot apparatus is passable for the robot apparatus.

13. The robot control system according to claim 3,
wherein the control information is an allowable upper limit on an acceleration value or an angular acceleration value.

14. The robot control system according to claim 13,
wherein the robot apparatus uses new control information received from the control apparatus and performs, in accordance with the new control information received from the control apparatus, an operation for preventing a carried object from falling.

15. The robot control system according to claim 3,
wherein the control information is information regarding an allowable range of motion for a movable unit.

16. The robot control system according to claim 15,
wherein, when an external form of the robot apparatus changes, the control information is generated for a changed external form.

17. The robot control system according to claim 3,
wherein the imaging apparatus includes a plurality of cameras that capture from different directions an external appearance of the robot apparatus placed at a predetermined position, and
the control information is generated from positional information of each of the plurality of cameras with respect to a position at which the robot apparatus is placed and images captured by each of the plurality of cameras.

18. The robot control system according to claim 3,
wherein the imaging apparatus includes a camera that captures an external appearance of the robot apparatus in operation a plurality of times, and
the control information is generated from a distance traveled by the robot apparatus and a plurality of images captured by the camera.

19. A robot apparatus comprising:
a control unit that autonomously controls operation of the robot apparatus in accordance with control information provided to the robot apparatus;
a receiving unit that receives update information to be used to update the control information, the update information being generated in accordance with a captured image of an external appearance of the robot apparatus, and
an update unit that updates the control information in accordance with the update information received by the receiving unit.

20. A non-transitory computer readable medium storing a program causing a computer to execute a process for controlling a robot apparatus, the process comprising:
capturing an image of a robot apparatus that operates autonomously in accordance with control information provided to the robot apparatus;
transmitting to the robot apparatus update information that is generated in accordance with the image captured in the image capturing and that is to be used to update the control information; and
updating the control information in accordance with update information received by the robot apparatus.
